(19) United States
(12) Patent Application Publication
(10) Pub. No.: US 2008/0189337 A1
(43) Pub. Date: Aug. 7, 2008

(54) FILE MANAGING METHOD AND DATA RECORDING APPARATUS

(76) Inventor: Jin SEO, Seoul (KR)

Correspondence Address: BIRCH STEWART KOLASCH & BIRCH, PO BOX 747, FALLS CHURCH, VA, 22040-0747, US

(21) Appl. No.: 12/023,594

(22) Filed: Jan. 31, 2008

(30) Foreign Application Priority Data
Feb. 1, 2007 (KR) 10-2007-0010508

(51) Int. Cl. G06F 17/30

(52) U.S. Cl. 707/200; 707/E17.01

(57) ABSTRACT

A method for efficiently managing the size of a file and an apparatus for recording data constituting such a file are disclosed. The file includes a header area and a data area. The header area includes a file size indicator. The file size indicator includes first information and second information. The first information is main information about the size of the file, and the second information is auxiliary information about the file size.

This application claims the benefit of the Korean Patent Application No. 10-2007-0010508, filed on Feb. 1, 2007, which is hereby incorporated by reference as if fully set forth herein.

### BACKGROUND OF THE INVENTION

1. Field of the Invention

The present invention relates to a file managing method and a data recording apparatus, and more particularly, to a method for efficiently managing the size of a file and an apparatus for recording data constituting such a file.

2. Discussion of the Related Art

In a recent information society, it has been possible to acquire image information of high-definition and large capacity. In addition, it has been possible to transform various information like image information, into a file format. And the capacity of such files is on an increasing trend with the development of technologies. Furthermore, the capacity of recording media capable of recording such files is also increasing. Therefore, there is a need for a file managing method appropriate to such trends.

### SUMMARY OF THE INVENTION

Accordingly, the present invention is directed to a file managing method and a data recording apparatus that substantially obviate one or more problems due to limitations and disadvantages of the related art.

An object of the present invention is to provide a file managing method and a data recording apparatus for coping with large capacity, high picture quality, long time recordings.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for managing a file including a header area and a data area, the header area including a file size indicator, the file size indicator including first information and second information, wherein the first information being main information about a size of the file, the second information being auxiliary information about the size of the file.

In another aspect of the present invention, a data recording apparatus comprises: an encoder configured to convert a file into a certain format having first information and second information, the first information as main information about a size of the file, the second information as auxiliary information about the size of the file; a pickup unit configured to record a signal of the converted format on a recording medium; and a controller configured to control the encoder and pickup unit.

In yet another aspect of the present invention, a method for indicating a size of a file comprises: determining a unit value based on a type of a file system; generating first information and second information using the unit value, wherein the first information is main information about the size of the file) and the second information is auxiliary information about the file size; and recording the first information and second information in a file size indicator.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view showing one embodiment of a file structure according to the present invention;

FIG. 2 is a view showing one embodiment of a file managing method according to the present invention;

FIG. 3 is a view showing another embodiment of the file managing method according to the present invention;

FIG. 4 is a view showing another embodiment of the file managing method according to the present invention; and

FIG. 5 is a block diagram showing one embodiment of a data recording/reproducing apparatus according to the present invention.

### DESCRIPTION OF SPECIFIC EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

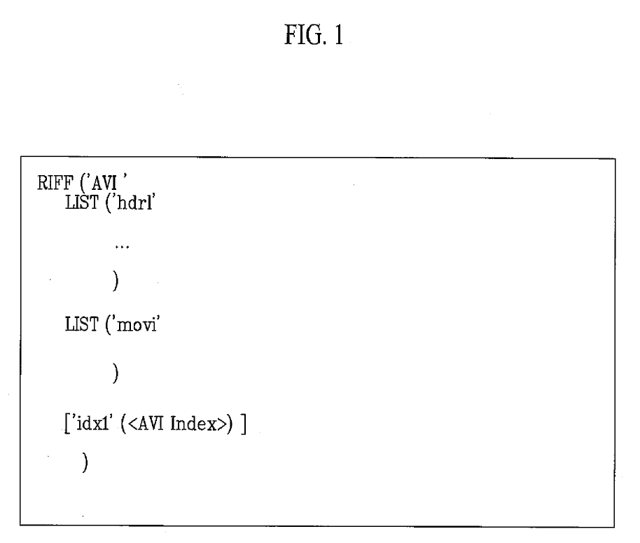

FIG. 1 shows one embodiment of the structure of a file in which data is recorded, according to the present invention. The file according to the present invention broadly includes three constituent elements, a header list including header information, a movie list including audio and video signals, and an index list including location information of various data included in the file. The index list is optional, and has the advantage of facilitating data accessibility during a random access operation.

This file structure can include data on a block basis. Such a block may be, for example, a chunk. In the present invention, an ‘RIFF AVI’ file can also be treated as one chunk. The RIFF AVI chunk also includes a sub chunk of a list chunk. In FIG. 1, the list chunk includes, for example, a header list chunk, movie list chunk, and index list chunk.

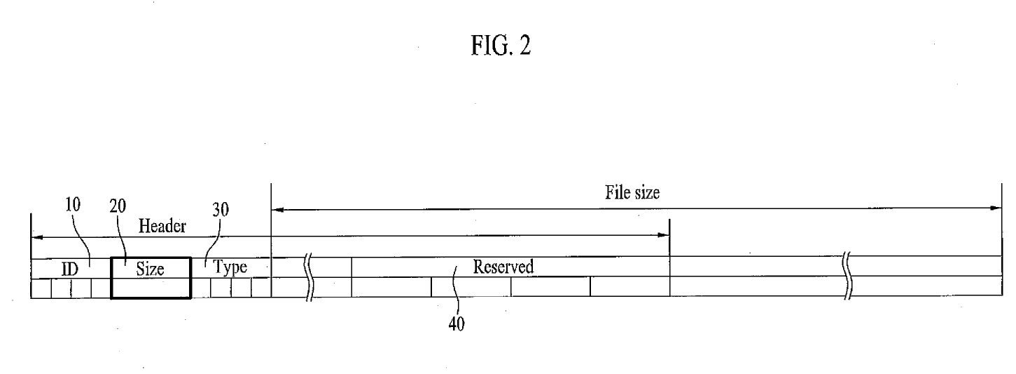

FIG. 2 shows a first embodiment of a file managing method according to the present invention. The header area of a file is assigned a header list that manages general information of the file. For convenience of managing a file, the header area may be assigned at the beginning of the file. The header list includes basic information of the file including a file identifier (ID), a file size and a file type. In this connection, the header area includes a file ID area 10, a file size area 20, and a file type area 30. For example, in the case where the format of the file is a resource interchange file format (RIFF), a character string such as ‘RIFF’ may be provided as the file ID. The file type represents the type of a file to be recorded/played back. For example, in the case where the file to be played back is an audio video interleaving (AVI) file, a character string such as ‘AVI’ may be provided as the file type. The file size represents the size of the entire area of the file, with the exception of the file ID area 10, file size area 20 and file type area 30 included in the header area. In some cases, some of the excluded areas may be included to represent the file size.

FIG. 2 also shows an example of indication of the file size in the header area. In the embodiment of FIG. 2, the file size area 20 is assigned to the header area in proportion to the file size. For example, in the case where the file size is 4 G bytes, 4 bytes may be assigned to the file size area 20 of the header area. When the file size is larger, a larger area may be assigned to the file size area 20 in proportion to the file size. This method has the advantage of indicating the file size in a simple manner. However, where the file size area 20 is extended with no limitation in size, a problem may occur in compatibility with other file managing methods. Also, when the file size area 20 cannot be further extended, a recordable file size is limited. As a result, there may be a problem that a file in recording must be closed and a new file must be again created.

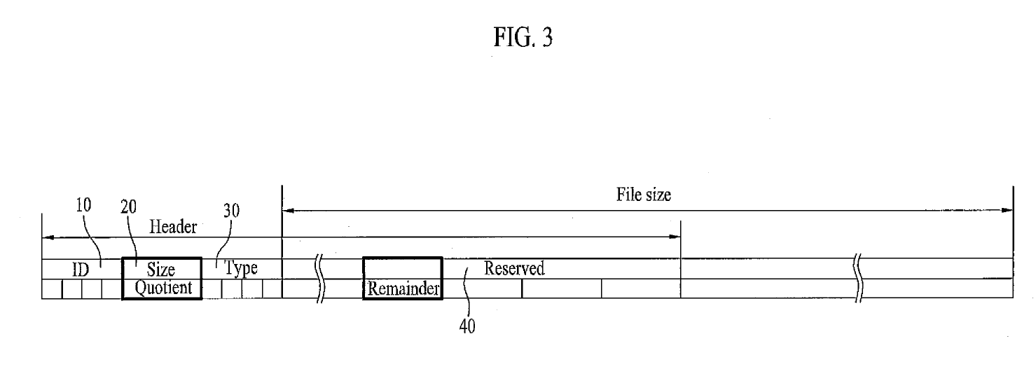

FIG. 3 shows a second embodiment of the file managing method according to the present invention. In FIG. 3, first information, which is main information about the size of a file, and second information, which is auxiliary information about the size of the file, are included in a header area of the file. Here, the first information is a quotient of division of the file size by a unit value, and the second information is a remainder of the division of the file size by the unit value. The first information is included in a file size area 20, and the second information is assigned to a portion of a reserved area 40 of the header area. The unit value may be different depending on the type of a file system and the size of the file size area 20 assigned to the header area.

For example, in a FAT 64 file system, the maximum size of one file is 8 G bytes. When the size of the file size area 20 assigned to the header area is, for example, 4 bytes, the unit value is preferably 4 G bytes. For example, in the case where the file size is 5 G bytes and the unit value is 4 G bytes, ‘1’ is recorded in the file size area 20 and ‘1 G’ is represented in the reserved area 40. It should be noted here that the areas in which the first information and the second information are recorded can be transposed and the first information and the second information can be recorded in adjacent areas in the file structure. This method has the advantage of increasing the file size while maintaining its compatibility with other file managing methods.

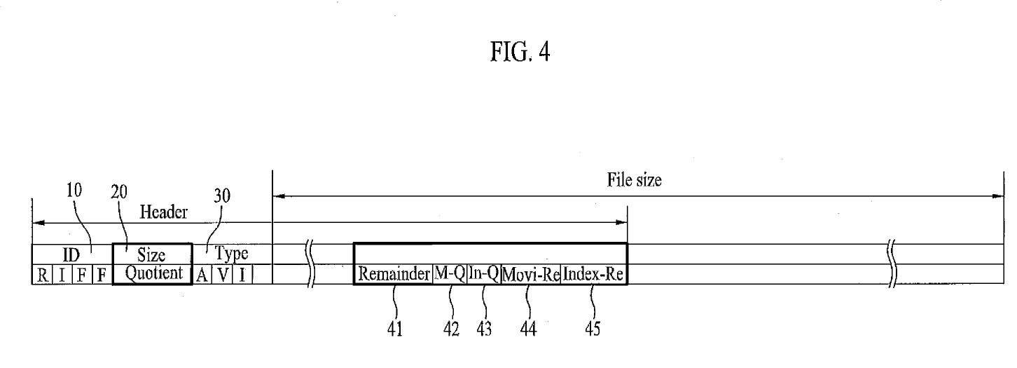

FIG. 4 shows a third embodiment of the file managing method according to the present invention. In the embodiment of FIG. 4, the entire size of a file and the sizes of constituent elements of the file are together expressed. For example, when a file to be played back is an AVI file, it may include a movie list or index list as an example of the constituent elements. The movie list includes video and audio signals, and the index list includes location information of various data included in the file. In FIG. 4, the size of each area of the file is indicated using the file size indicating method of FIG. 3. Namely, a quotient of division of the size of the movie list by a unit value is recorded in an M_Q area 42, and a remainder of the division of the size of the movie list by the unit value is recorded in a Movi_Re area 44. Here, information about the size of the movie list can be set as third information. Also, a quotient of division of the size of the index list by the unit value is recorded in an In_Q area 43, and a remainder of the division of the size of the index list by the unit value is recorded in an Index_Re area 45. Here, information about the size of the index list can be set as fourth information. Indicating the sizes of the movie list and index list in this manner can facilitate file management in a header area of the file. The unit value can be determined in the same manner as in the embodiment of FIG. 3.

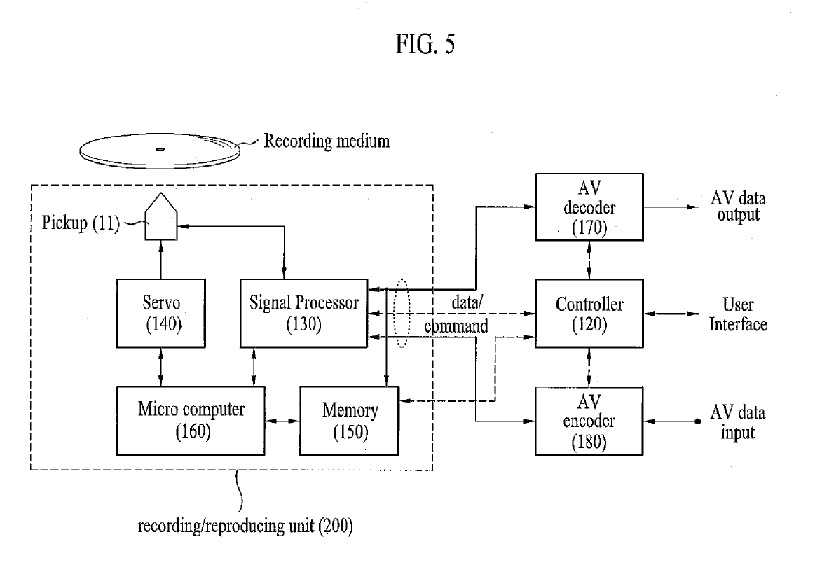

FIG. 5 is a block diagram showing one embodiment of a data recording apparatus according to the present invention. The data recording apparatus according to the present invention includes a recording/playback unit 200 for recording data on a recording medium or playing back data recorded on the recording medium, and a controller 120 for controlling the recording/playback unit 200.

The recording/playback unit 200 includes a pickup 110 for recording data on the recording medium or reading data recorded on the recording medium, a signal processor 130 for demodulating an output signal from the pickup 110 into the original signal or modulating a signal to be recorded into a signal recordable on the recording medium, a servo device 140 for controlling the pickup 110 to accurately read a signal from the recording medium or accurately record a signal on the recording medium, and a microcomputer 160 for controlling the above constituent elements.

The controller 120 controls all constituent elements of the data recording apparatus. Particularly, in connection with the present invention, the controller 120 receives user commands, etc. through a user interface, and transmits, to the recording/playback unit 200, a command for recording of data on the recording medium or playback of data recorded on the recording medium.

An AV encoder 180 is operated under the control of the controller 120 to convert an input signal into a signal of a specific format and provide the converted signal to the signal processor 130 to record that signal on the recording medium. Also, the AV encoder 180 constructs a header area of a file according to the file managing method of the present invention. That is, as in the first embodiment of the present invention, the AV encoder 180 assigns a file size area of a certain size to the header area to indicate the file size. In the first embodiment, the size of file size area is proportional to the entire size the file. Alternatively, as in the second embodiment of the present invention, the AV encoder 180 may assign a file size area of a certain size to the header area and assign an area of a certain size to a reserved area. First information, which is main information about the file size, is recorded in the file size area. Second information, which is auxiliary information about the file size, is recorded in the reserved area. As another alternative, as in the third embodiment of FIG. 4, the entire size of the file and the sizes of constituent elements of the file may be together expressed in the header area. Also, the AV encoder 180 may convert the input signal into an MPEG4 transport stream.

An AV decoder 170 decodes a signal encoded by the present invention and provides the decoded signal to the user.

In the present invention, the controller 120 and the microcomputer 160 can function separately as a first control unit and a second control unit. Alternatively, the controller 120 and the microcomputer 160 may be integrated into a single control unit.

As apparent from the above description, according to the file managing method and data recording apparatus of the present invention, it is possible to readily enlarge the size of a file in large capacity, long time recordings, so as to promote stability and convenience of a system.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for managing a file including a header area and a data area, the header area including a file size indicator, the file size indicator including first information and second information,
wherein the first information being main information about a size of the file, the second information being auxiliary information about the size of the file.

2. The method according to claim 1, wherein:
the first information is a quotient of division of the file size by a unit value; and
the second information is a remainder of the division of the file size by the unit value.

3. The method according to claim 2, wherein the unit value is determined depending on a type of a file system.

4. The method according to claim 3, wherein the unit value is 4 G bytes when the the type of file system is FAT 64.

5. The method according to claim 1, wherein the data area includes movie data and index data.

6. The method according to claim 5, wherein the file size indicator further includes third information indicating a size of the movie data.

7. The method according to claim 5, wherein the file size indicator further includes fourth information indicating a size of the index data.

8. The method according to claim 1, wherein the file size indicator has a size of 16 bytes.

9. The method according to claim 1, wherein the file is an MPEG4 stream file.

10. A data recording apparatus comprising:
an encoder configured to convert a format of a file into a certain format having first information and second information, the first information being main information about a size of the file, the second information being auxiliary information about the size of the file;
a pick up unit configured to record a signal of the converted format on a recording medium; and
a controller configured to control the encoder and recording unit.

11. The data recording apparatus according to claim 10, wherein:
the first information is a quotient of division of the file size by a unit value; and
the second information is a remainder of the division of the file size by the unit value.

12. The data recording apparatus according to claim 11, wherein the unit value is determined depending on a type of a file system.

13. The data recording apparatus according to claim 12, wherein the unit value is 4 G bytes when the type of the file system is FAT 64.

14. The data recording apparatus according to claim 10, wherein the converted file format is an MPEG4 stream format.

15. A method for indicating a size of a file, comprising:
determining a unit value based on a type of a file system;
generating first information and second information using the unit value, wherein the first information is main information about the size of the file,the second information is auxiliary information about the size of the file; and
recording the first information and second information in a file size indicator.

16. The method according to claim 15, wherein the unit value is 4 G bytes when the type of file system is FAT 64.

17. The method according to claim 15, wherein:
the first information is a quotient of division of the file size by the unit value; and
the second information is a remainder of the division of the file size by the unit value.
